(19) United States
(12) Patent Application Publication
(10) Pub. No.: US 2011/0148851 A1
(43) Pub. Date: Jun. 23, 2011

(54) Clock data recovery circuit, data transfer device for display device, and data transfer method for display device

(75) Inventors: Akio Sugiyama, Kanagawa (JP); Yoshihiko Hori, Kanagawa (JP); Takashi Nose, Kanagawa (JP)

(73) Assignee: Renesas Electronics Corporation, Kanagawa (JP)

(21) Appl. No.: 12/926,959

(22) Filed: Dec. 20, 2010

(30) Foreign Application Priority Data
Dec. 22, 2009 (JP) 2009-290358

(51) Int. Cl. H04L 7/00; G06F 3/038

(52) U.S. Cl. 345/213; 375/355

(57) ABSTRACT

A clock data recovery circuit includes a sampling circuit SC that samples input data by 2× over sampling, a frequency detection circuit FD that detects a frequency difference between the input data sampled by the sampling circuit SC and a recovery clock, a phase detection circuit PD that detects a phase difference between the input data sampled by the sampling circuit SC and the recovery clock, a voltage control oscillator circuit VCO that outputs the recovery clock to the sampling circuit SC at least according to the phase difference detected by the phase detection circuit PD, and a frequency detection control circuit FDC that stops an operation of the frequency detection circuit FD while receiving display data as the input data.

### INCORPORATION BY REFERENCE

This application is based upon and claims the benefit of priority from Japanese patent application No. 2009-290358, filed on Dec. 22, 2009, the disclosure of which is incorporated herein in its entirety by reference.

### BACKGROUND

1. Field of the Invention

The present invention relates to a clock data recovery circuit, a data transfer apparatus for display device, and a data transfer method for display device.

2. Description of Related Art

An increase in the size of the display device poses a problem for a data transfer method to a display driver circuit. Further, the improvement in the resolution and higher speed of drive timings contribute to accelerate data transfer. Yamaguchi et al. (“A 2.0 Gb/s Clock-Embedded Interface for Full-HD 10b 120 Hz LCD Drivers with 1/5-Rate Noise-Tolerant Phase and Frequency Recovery”, Solid-State Circuits Conference—Digest of Technical Papers, 2009.ISSCC 2009.IEEE International, pp. 192-193, February, 2009.) disclose a high-speed data transfer system for display devices by Point-to-Point embedded clock.

A clock data recovery (CDR) circuit disclosed by Yamaguchi et al. is described with reference to FIGS. 7 and 8. FIG. 7 is a block diagram of a CDR circuit 1 disclosed by Yamaguchi et al. FIG. 8 is a block diagram of a display device in which the CDR circuit 1 of FIG. 7 is applied to a driver.

First, a display device of FIG. 8 incorporating the CDR circuit of FIG. 7 is explained. As shown in FIG. 8, this display device includes a timing controller, the driver, and a display element. The timing controller includes a transmission circuit TX. The driver includes the CDR circuit 1 and a display element driver circuit 2.

The transmission circuit TX converts display data, which is a parallel signal, and a command into a serial signal, and transfers the serial signal to the CDR circuit 1. As described later in detail, the display data and the command are alternately transferred. The command includes various control signals such as a data start signal that indicates the start of the display data.

The CDR circuit 1 converts the serial input data transferred from the timing controller into parallel data, and recovers the clock and the data. The recovered clock is referred to as a recovery clock. The data is output to the display element driver circuit 2 via a bus.

Next, the CDR circuit of FIG. 7 is explained. As shown in FIG. 7, the CDR circuit disclosed by Yamaguchi et al. detects a frequency and a phase using 4× over sampling. The CDR circuit 1 includes a sampling circuit SC, a frequency detection circuit FD, a phase detection circuit PD, a charge pump CP1 for FD, a charge pump CP2 for PD, a loop filter LF, and a voltage control oscillator circuit VCO.

The sampling circuit SC samples serial input data transferred from the timing controller based on the recovery clock. The sampled data is output to the frequency detection circuit FD, the phase detection circuit PD, and the display element driver circuit 2.

The frequency detection circuit FD detects a frequency difference between the input data sampled by the sampling circuit SC and the recovery clock. If the frequency of the recovery clock is lower than the frequency of the input data, the frequency detection circuit FD outputs an UP signal for increasing the frequency of the recovery clock to the charge pump CP1 for FD. If the frequency of the recovery clock is higher than the frequency of the input data, the frequency detection circuit FD outputs a DOWN signal for reducing the frequency of the recovery clock to the charge pump CP1 for FD.

The phase detection circuit PD detects a phase difference between the input data sampled by the sampling circuit SC and the recovery clock. If the phase of the recovery clock is behind the phase of the input data, the phase detection circuit PD outputs the UP signal for advancing the phase of the recovery clock to the charge pump CP1 for PD. If the phase of the recovery clock is ahead of the phase of the input data, the phase detection circuit PD outputs the DOWN signal for delaying the phase of the recovery clock to the charge pump CP1 for PD.

The charge pump CP1 for FD and the charge pump CP2 for PD output an analog current signal corresponding to the input UP or DOWN signal.

The loop filter LF generates a control voltage signal according to the analog current signal input from the charge pump CP1 for FD and the charge pump CP2 for PD.

Then, the voltage control oscillator circuit VCO generates a clock CLK according to the control voltage signal which is input from the loop filter LF. In a similar way as the data, the clock CLK is output to the display element driver circuit 2, and fed back to the sampling circuit SC as the recovery clock.

FIG. 9 illustrates an algorithm of frequency detection by the 4× over sampling shown in FIG. 10.7.3 disclosed by Yamaguchi et al. The waveform of the input data in the top row illustrates the case that an oscillation frequency of the voltage control oscillator circuit VCO is low as compared to the input data frequency. In this case, as indicated by the shaded area, a transition of the signal level in the clock phase 2-4 and 5-6 is detected. As a result, the frequency detection circuit FD detects that the oscillation frequency is low.

On the other hand, the waveform of the input data of the bottom row indicates the case that the oscillation frequency of the voltage control oscillator circuit VCO is high as compared to the input data frequency. In this case, as indicated by the shaded area, transition of the signal level in the clock phases 0-2 and 6-7 and no transition of the signal level in the clock phase 2-6 are detected. As a result, the frequency detection circuit FD detects that the oscillation frequency is high.

The waveform of the input data of the middle row indicates the case that the input data frequency matches the oscillation frequency of the voltage control oscillator circuit VCO. In this case, the frequency detection circuit FD does not evaluate the oscillation frequency to be neither high nor low.

Note that FIG. 10 illustrates the relationship between the clock phase after PLL lock and the input data. The PLL lock refers to the state in which the frequency and phase of the input data match those of the clock, which is oscillated by the voltage control oscillator circuit VCO. In the 4× over sampling, edges of the input data are synchronized at the positions of the clock phase 0, 4, and 8 . . . as shown in FIG. 10, and the input data is sampled at the positions of the clock phase 2, 6, and 10 . . . (which are at the middle of bits).

### SUMMARY

However, the present inventors have found a problem that in the clock data recovery circuit disclosed by Yamaguchi et al., the circuit size and power consumption are large, and EMI characteristics are low, as the 4× over sampling is adopted.

An exemplary embodiment of the present invention is a clock data recovery circuit that includes a sampling circuit that samples input data by 2× over sampling, a frequency detection circuit that detects a frequency difference between the input data sampled by the sampling circuit and a recovery clock, a phase detection circuit that detects a phase difference between the input data sampled by the sampling circuit and the recovery clock, a voltage control oscillator circuit that outputs the recovery clock to the sampling circuit at least according to the phase difference detected by the phase detection circuit, and a frequency detection control circuit that stops an operation of the frequency detection circuit while receiving display data as the input data.

Another exemplary embodiment of the present invention is a data transfer apparatus for a display device that includes a timing controller that transmits transfer data and a display element driver circuit that receives the transfer data transmitted from the timing controller. Further, the display element driver circuit includes a sampling circuit that samples input data by 2× over sampling, a frequency detection circuit that detects a frequency difference between the input data sampled by the sampling circuit and a recovery clock, a phase detection circuit that detects a phase difference between the input data sampled by the sampling circuit and the recovery clock, a voltage control oscillator circuit that outputs the recovery clock to the sampling circuit at least according to the phase difference detected by the phase detection circuit, and a frequency detection control circuit that stops an operation of the frequency detection circuit while receiving display data as the input data.

Another exemplary embodiment of the present invention is a data transfer method for a display device that transfers data from a timing controller to a display element driver circuit. The data transfer method includes sampling transfer data by 2× over sampling, detecting a phase difference between the sampled transfer data and a recovery clock instead of a frequency difference while the transfer data is display data so as to generate the recovery clock, detecting the frequency difference and the phase difference of the sampled transfer data while the transfer data is not the display data so as to generate the recovery clock.

In the present invention, the frequency detection control circuit is included that stops the operation of the frequency detection circuit while receiving the display data as the input data, and adopts the 2× over sampling. Therefore, the present invention can provide a clock data recovery circuit with small circuit size, low power consumption and excellent EMI characteristics.

The present invention can provide a clock data recovery circuit with small circuit size, low power consumption, and excellent EMI characteristics.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a block diagram of a CDR circuit according to a first exemplary embodiment;

FIG. 2 is a block diagram of a display device in which the CDR circuit of FIG. 1 is applied to a driver;

FIG. 3 illustrates an algorithm of frequency detection by 2× over sampling;

FIG. 4 illustrates a relationship between a clock phase and input data after PLL lock in the 2× over sampling;

FIG. 5A illustrates transfer data, which is input to the CDR circuit of the first exemplary embodiment, and an operational state of a frequency detection circuit;

FIG. 5B illustrates transfer data, which is input to a CDR circuit of FIG. 7, and an operational state of a frequency detection circuit;

FIG. 6A illustrates a case when a pattern “1, 1” in which same level signals continue for only two bits is input in the 2× over sampling;

FIG. 6B illustrates a case when a pattern “1, 1” in which same level signals continue for only two bits is input in the 4× over sampling;

FIG. 7 is a block diagram of a CDR circuit disclosed by Yamaguchi et al.;

FIG. 8 is a block diagram of a display device in which the CDR circuit of FIG. 7 is applied to a driver;

FIG. 9 illustrates an algorithm of frequency detection by the 4× over sampling; and

FIG. 10 illustrates a relationship between a clock phase and input data after PLL lock in the 4× over sampling.

### DETAILED DESCRIPTION OF THE EXEMPLARY EMBODIMENTS

Hereinafter, specific exemplary embodiments incorporating the present invention are described with reference to the drawings. However, the present invention is not necessarily limited to following exemplary embodiments. For the clarity of the explanation, the following explanation and drawings are simplified as appropriate.

### First Exemplary Embodiment

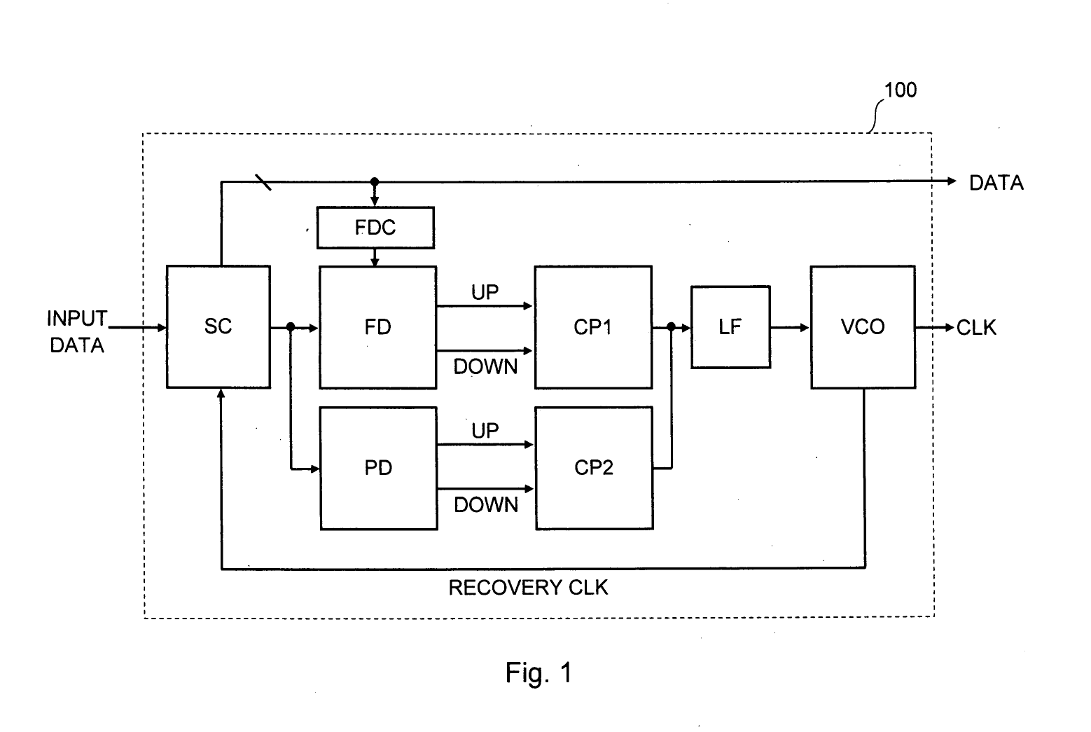

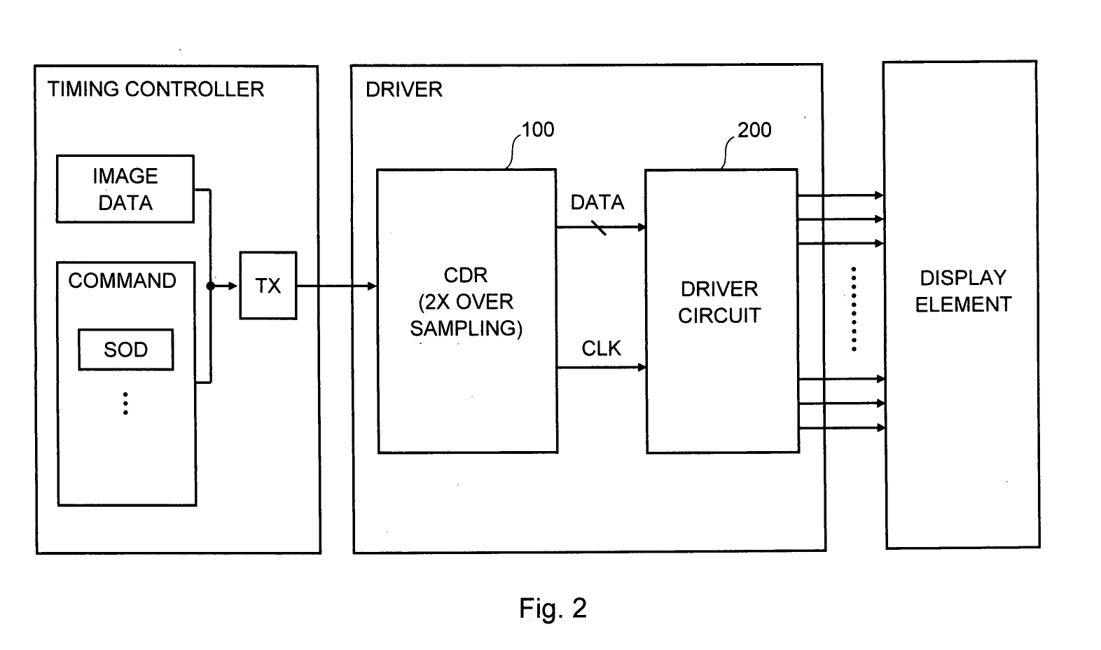

A clock data recovery (CDR) circuit according to a first exemplary embodiment of the present invention is described with reference to FIGS. 1 and 2. FIG. 1 is a block diagram of a CDR circuit 100 according to the first exemplary embodiment. FIG. 2 is a block diagram of a display device in which the CDR circuit 100 is applied to a driver.

First, the display device shown in FIG. 2 incorporating the CDR circuit of FIG. 1 is described. As shown in FIG. 2, the display device includes a timing controller, a driver, and a display element. The timing controller includes a transmission circuit TX. The driver includes the CDR circuit 100 and a display element driver circuit 200.

The transmission circuit TX converts display data, which is a parallel signal, and a command into a serial signal and transfers the serial data to the CDR circuit 100. As described later in detail, the display data and the command are alternately transferred. The command includes various control signals such as a data start signal SOD that indicates a start of the display data.

The CDR circuit 100 recovers a clock CLK while converting the input serial signal into a parallel signal. Then, the data and the clock CLK are output to the display element driver circuit 200. In response to the clock CLK, the display element driver circuit 200 outputs the display data to the display element.

Next, the CDR circuit of FIG. 1 is described. As shown in FIG. 1, the CDR circuit according to the first exemplary embodiment includes a sampling circuit SC, a frequency detection circuit FD, a phase detection circuit PD, and a charge pump CP1 for FD, a charge pump CP2 for PD, a loop filter LF, a voltage control oscillator circuit VCO, and a frequency detection control circuit FDC.

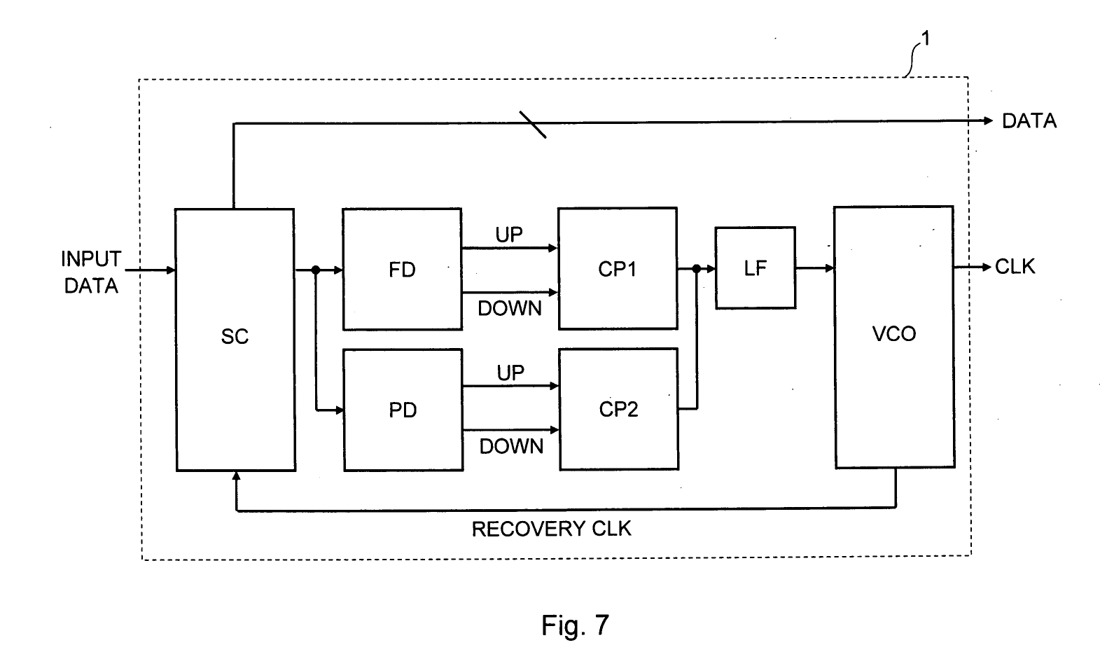

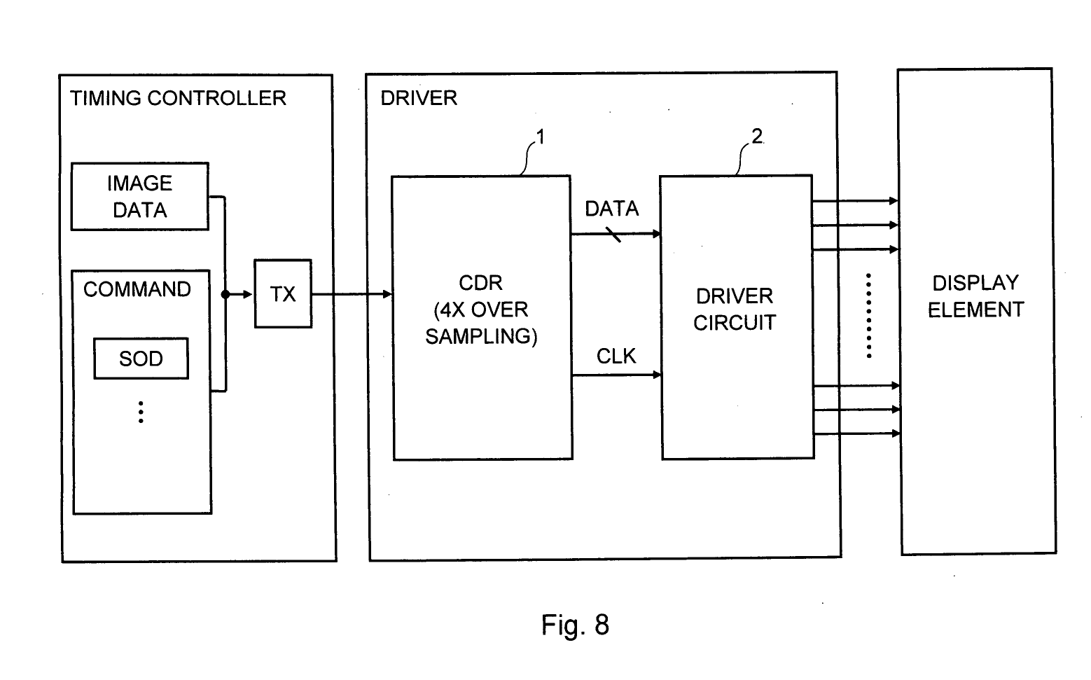

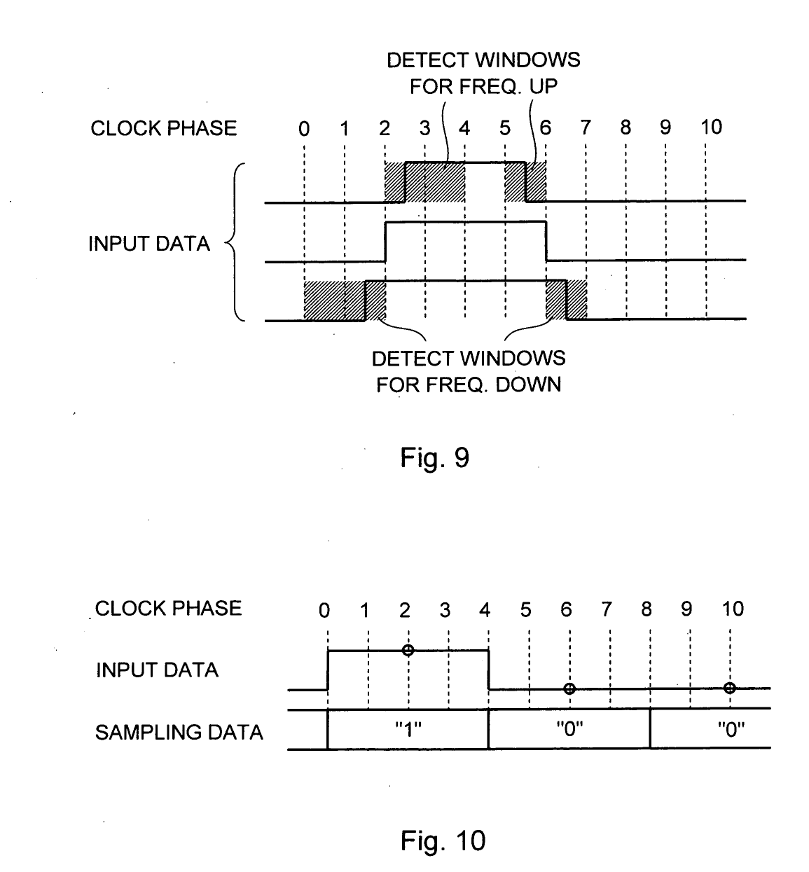

The sampling circuit SC samples the serial input data transferred from the timing controller according to the recovery clock. The sampled data signal is output to the frequency detection circuit FD, the phase detection circuit PD, and the display element driver circuit 200. As the sampling circuit SC according to the present invention adopts the 2× over sampling instead of the 4× over sampling, the circuit size can be smaller than the sampling circuit SC in the CDR circuit of FIG. 7.

The frequency detection circuit FD detects a frequency difference between the input data, which is sampled by the sampling circuit SC, and the recovery clock. If the frequency of the recovery clock is lower than the frequency of the input data, the frequency detection circuit FD outputs an UP signal for increasing the frequency of the recovery clock to the charge pump CP1 for FD. If the frequency of the recovery clock is higher than the frequency of the input data, the frequency detection circuit FD outputs a DOWN signal for reducing the frequency of the recovery clock to the charge pump CP1 for FD.

More specifically, the frequency detection circuit FD combines an integration function and a comparator function. Accordingly, if the number that the oscillation frequency is detected as “low” exceeds a predetermined number, the frequency detection circuit FD outputs the UP signal. On the other hand, if the number that the oscillation frequency is detected as “low” does not exceed the predetermined number, the frequency detection circuit FD will not output the UP signal.

Similarly, if the number that the oscillation frequency is detected as “high” exceeds a predetermined number, the frequency detection circuit FD outputs the DOWN signal. On the other hand, if the number that the oscillation frequency is detected as “high” does not exceed the predetermined number, the frequency detection circuit FD will not output the DOWN signal.

The oscillation frequency may be detected as “low” or “high” due to the jitter in the input signal even after the PLL lock. However, as the number of such detection is not many, the UP or DOWN signal is not output by the above function of the frequency detection circuit FD, thereby maintaining the PLL lock state.

More particularly, the UP or DOWN signal is output when the number that the oscillation frequency is detected as “low” or “high” exceeds the predetermined number (threshold) within a predetermined period.

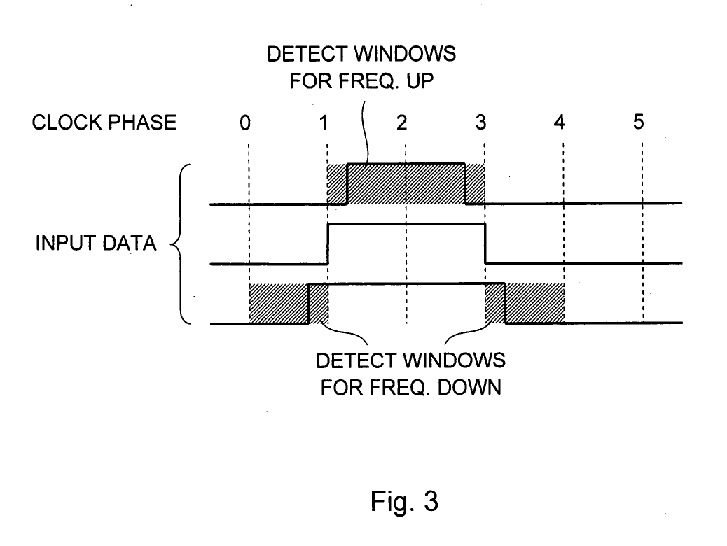

FIG. 3 illustrates an algorithm of frequency detection by the 2× over sampling. The waveform of the input data in the top row illustrates the case that an oscillation frequency of the voltage control oscillator circuit VCO is low as compared to the input data frequency. In this case, as indicated by the shaded area, a transition of the signal level in the clock phase 1-2 and 2-3 is detected. As a result, the frequency detection circuit FD detects that the oscillation frequency is low.

On the other hand, the waveform of the input data of the bottom row indicates the case that the oscillation frequency of the voltage control oscillator circuit VCO is high as compared to the input data frequency. In this case, as indicated by the shaded area, transition of the signal level in the clock phases 0-1 and 3-4 and no transition of the signal level in the clock phase 1-3 are detected. As a result, the frequency detection circuit FD detects that the oscillation frequency is high.

The waveform of the input data of the middle row indicates the case that the input data frequency matches the oscillation frequency of the voltage control oscillator circuit VCO. In this case, the frequency detection circuit FD does not evaluate the oscillation frequency to be neither high nor low.

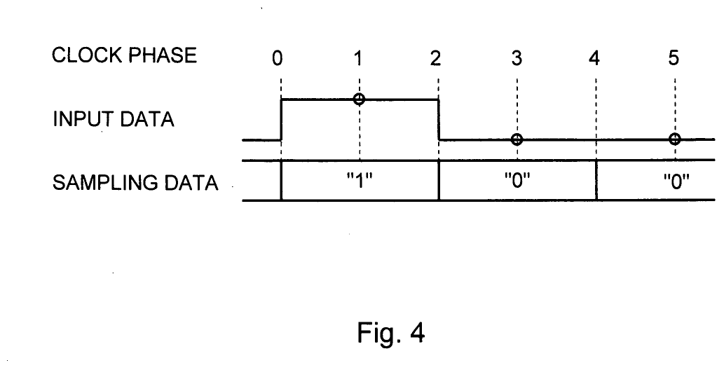

FIG. 4 shows the relationship between the clock phase after the PLL lock and the input data. In the 2× over sampling, edges of the input data are synchronized at the positions of the clock phases 0, 4, and 8 . . . as shown in FIG. 4, and the input data is sampled at the positions of the clock phases 1, 3 and 5 . . . (which are the middle of bits).

The phase detection circuit PD detects a phase difference between the input data sampled by the sampling circuit SC and the recovery clock. If the phase of the recovery clock is behind the phase of the input data, the phase detection circuit PD outputs the UP signal for advancing the phase of the recovery clock to the charge pump CP2 for PD. If the phase of the recovery clock is ahead of the phase of the input data, the phase detection circuit PD outputs the DOWN signal for delaying the phase of the recovery clock to the charge pump CP2 for PD.

The charge pump CP1 for FD and the charge pump CP2 for PD output an analog current signal corresponding to the input UP or DOWN signal.

The loop filter LF generates a control voltage signal according to the analog current signal input from the charge pump CP1 for FD and the charge pump CP2 for PD.

Then, the voltage control oscillator circuit VCO generates a clock CLK according to the control voltage signal which is input from the loop filter LF. In a similar way as the data, the clock CLK is output to the display element driver circuit 200 of FIG. 2, and fed back to the sampling circuit SC as the recovery clock. As the sampling circuit SC according to the present invention adopts the 2× over sampling instead of the 4× over sampling, the circuit size can be smaller than the sampling circuit SC in the CDR circuit of FIG. 7. Further, as the number of recovery clocks is half of the 4× over sampling, the current consumption is smaller and the EMI characteristics are improved.

The data signal output from the sampling circuit SC is input to the frequency detection control circuit FDC. The frequency detection circuit FD is stopped in response to an FD stop signal included in the data signal. The frequency detection control circuit FDC is not included in the CDR circuit 1 of FIG. 7, and is a newly added component. However, the contribution of the circuit size reduction effect of the sampling circuit SC and the voltage control oscillator circuit VCO is significant enough to reduce the entire circuit size.

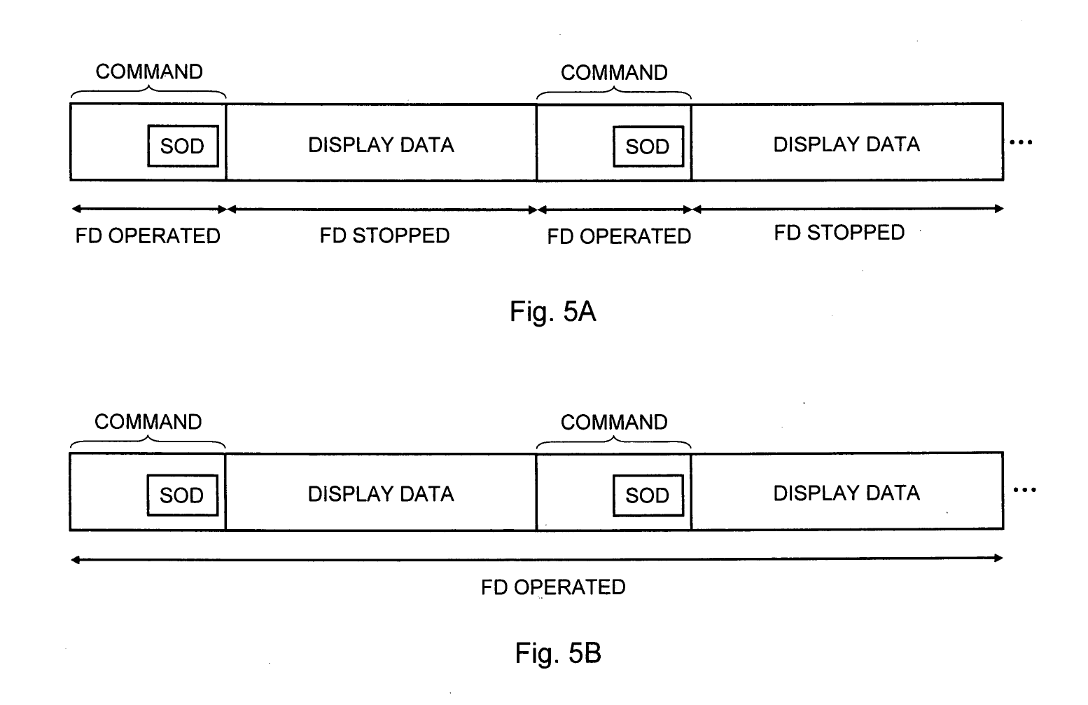

Hereinafter, an operation of the frequency detection circuit FD is described with reference to the drawings. FIG. 5A illustrates the transfer data, which is input to the CDR circuit 100 of this exemplary embodiment, and the operational state of the frequency detection circuit. FIG. 5B illustrates the transfer data, which is input to the CDR circuit 1 of FIG. 7, and the operational state of the frequency detection circuit. As shown in FIGS. 5A and 5B, the display data and the command are alternately transferred as the transfer data to the sampling circuit SC. The display data here refers to the data displayed in the display elements, and the command refers to the transfer data other than the display data such as the control signal.

As shown in FIG. 5A, in the CDR circuit 100 according to this exemplary embodiment, the frequency detection circuit FD is operated while receiving the command, and the frequency detection circuit FD stops while receiving the display data. Specifically, the frequency detection circuit FD is stopped using the data start signal SOD included in the command as the abovementioned FD stop signal. In this exemplary embodiment, the period to receive the display data is previously determined. Thus the operation of the frequency detection circuit FD is automatically returned after predetermined time (number of clocks) since the frequency detection circuit FD is stopped.

On the other hand, as shown in FIG. 5B, in the CDR circuit 1 of FIG. 7, the frequency detection circuit FD is operated at any time.

In the period to transfer the command, noise is tend to be generated and the PLL lock is prone to be unlocked. Therefore, PLL lock state is maintained by both the frequency detection circuit FD and the phase detection circuit PD so as to return the operation. On the other hand, in the period to transfer the display data, the PLL lock will not be unlocked by noise. Therefore, the frequency detection circuit FD can be stopped and the PLL lock state can be maintained only by the phase detection circuit PD.

On the other hand, in the case of the 2× over sampling, the frequency detection circuit FD must be stopped during the display data transfer period from the following reasons. Specifically, if a pattern in which the same level signals continue for only two bits after the PLL lock, such as “1, 0, 0, 1”, or “0, 1, 1, 0” is input, there is a possibility that the frequency detection circuit FD may malfunction in the 2× over sampling. The reason is explained hereinafter.

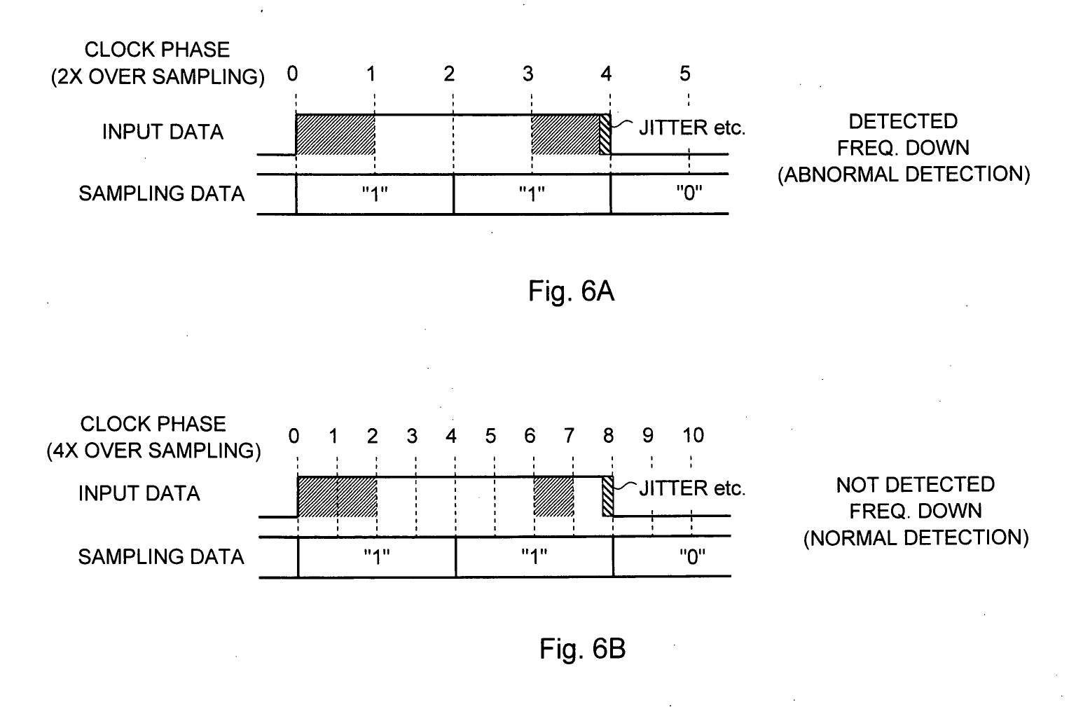

FIG. 6A illustrates the case when a pattern “1, 1”, in which the same level signals continue for only two bits, is input in the 2× over sampling. FIG. 6B illustrates the case when a pattern “1, 1”, in which the same level signals continue for only two bits, is input in the 4× over sampling.

As shown in FIG. 6A, in the 2× over sampling, the two bits input data “1, 1” may be erroneously evaluated as one bit input data “1” due to jitter and clock skew in the input signals. Consequently, there is a possibility that the frequency detection circuit FD may malfunction in a way to reduce the oscillation frequency of the voltage control oscillator circuit VCO.

On the other hand, as shown in FIG. 6B, even if there are jitter, clock skew, and the like in the input signals, erroneous evaluation will not be performed in the 4× over sampling.

As explained above, the inventors have found that it is no problem to stop the frequency detection circuit FD in the display data transfer period, and eliminated the risk of erroneous evaluation in the 2× over sampling. Then, by applying the 2× over sampling, the inventors have succeeded to provide the clock data recovery circuit that has small circuit size, low power consumption, and excellent EMI characteristics. Note that the frequency detection circuit FD is operating while the command is transferred. Therefore, it is necessary to specify command codes so that the frequency detection circuit FD may not malfunction, in a way that the pattern in which the same level signals continue for only two bits is less than or equal to the predetermined number (needless to say that such pattern may not be included at all). However, since the types of the command for display devices are limited, it is possible to allocate the command codes in the abovementioned way.

Although the present invention has been described with reference to the exemplary embodiments, the present invention is not limited to the above exemplary embodiments. Various modifications that can be understood by a person in the art within the scope of the present invention can be made to the configuration and details of the present invention.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

What is claimed is:

1. A clock data recovery circuit comprising:
a sampling circuit that samples input data by 2× over sampling;
a frequency detection circuit that detects a frequency difference between the input data and a recovery clock, the input data being sampled by the sampling circuit;
a phase detection circuit that detects a phase difference between the input data and the recovery clock, the input data being sampled by the sampling circuit;
a voltage control oscillator circuit that outputs the recovery clock to the sampling circuit at least according to the phase difference detected by the phase detection circuit; and
a frequency detection control circuit that stops an operation of the frequency detection circuit while receiving display data as the input data.

2. The clock data recovery circuit according to claim 1, wherein the voltage control oscillator circuit outputs the recovery clock while the frequency detection circuit is operating according to the frequency difference detected by the frequency detection circuit in addition to the phase difference detected by the phase detection circuit.

3. The clock data recovery circuit according to claim 1, wherein the input data while the frequency detection circuit is operating is specified in a way that a pattern in which a same level signal continues for only two bits is less than or equal to a predetermined number.

4. The clock data recovery circuit according to claim 1, wherein the frequency detection control circuit stops the operation of the frequency detection circuit in response to a data start signal.

5. The clock data recovery circuit according to claim 1, wherein
time for the display data is previously determined, and
the frequency detection circuit resumes the operation after predetermined time following the stop of the operation.

6. A data transfer apparatus for a display device comprising:
a timing controller that transmits transfer data; and
a display element driver circuit that receives the transfer data, the transfer data being transmitted from the timing controller, wherein the display element driver circuit comprises:
a sampling circuit that samples input data by 2× over sampling;
a frequency detection circuit that detects a frequency difference between the input data and a recovery clock, the input data being sampled by the sampling circuit;
a phase detection circuit that detects a phase difference between the input data and the recovery clock, the input data being sampled by the sampling circuit;
a voltage control oscillator circuit that outputs the recovery clock to the sampling circuit at least according to the phase difference detected by the phase detection circuit; and
a frequency detection control circuit that stops an operation of the frequency detection circuit while receiving display data as the input data.

7. The data transfer apparatus according to claim 6, wherein the voltage control oscillator circuit outputs the recovery clock while the frequency detection circuit is operating according to the frequency difference detected by the frequency detection circuit in addition to the phase difference detected by the phase detection circuit.

8. The data transfer apparatus according to claim 6, wherein the transfer data while the frequency detection circuit is operating is specified in a way that a pattern in which a same level signal continues for only two bits is less than or equal to a predetermined number.

9. A data transfer method for a display device that transfers data from a timing controller to a display element driver circuit, the data transfer method comprising:
sampling transfer data by 2× over sampling;
detecting a phase difference between the sampled transfer data and a recovery clock instead of a frequency difference while the transfer data is display data so as to generate the recovery clock;
detecting the frequency difference and the phase difference of the sampled transfer data while the transfer data is not the display data so as to generate the recovery clock.

10. The data transfer method according to claim 9, wherein the transfer data except the display data is specified in a way that a pattern in which a same level signal continues for only two bits is less than or equal to a predetermined frequency.
